(19) United States
(12) Patent Application Publication
(10) Pub. No.: US 2018/0211345 A1
(43) Pub. Date: Jul. 26, 2018

(54) AUTOMATED SYSTEM AND PROCESS FOR PROVIDING PERSONAL SAFETY

(71) Applicant: 802179 ALBERTA LTD, Calgary (CA)

(72) Inventors: Charles Alfred Bean, Calgary (CA); Daniel James Mulcahy, Cochrane (CA)

(21) Appl. No.: 15/745,856

(22) PCT Filed: Jul. 20, 2016
(86) PCT No.: PCT/CA2016/050853

§ 371 Date: Jan. 18, 2018

Related U.S. Application Data
(60) Provisional application No. 62/194,467, filed on Jul. 20, 2015.

(51) Int. Cl. G06Q 50/26; G01S 11/06; G01S 1/04; G06Q 30/00; G08B 21/02; H04B 17/318

(52) U.S. Cl. CPC G06Q 50/265; G01S 11/06; G01S 1/047; H04W 84/18; G08B 21/02; H04B 17/318; G06Q 30/018

(57) ABSTRACT

Various implementations for an automatic safety system for monitoring the use of personal protective equipment are provided. Various implementations for processes for monitoring the use of personal protective equipment are also provided. The system and methods involve the use of personal safety instruments comprising beacons, and a wearable electronic detection device carried by a user, configured to continuously or periodically monitor the distance between a user and the personal safety instruments. The system and processes may be used to prevent or limit the occurrence of accidents, incidents and/or injuries in hazardous work environments.

### CROSS-REFERENCE

This application claims the benefit of U.S. Provisional Patent Application No. 62/194,467 filed Jul. 20, 2015; the entire contents of Patent Application No. 62/194,467 are hereby incorporated by reference.

### FIELD OF THE DISCLOSURE

The present disclosure relates to systems and processes for providing safety to persons operating in hazardous environments, and, more particularly, to systems and processes applicable to environments requiring the use of protective clothing and articles.

### BACKGROUND OF THE DISCLOSURE

The following paragraphs are provided by way of background to the present disclosure. They are not, however, an admission that anything discussed therein is prior art or part of the knowledge of persons skilled in the art.

In the United States, each year approximately 900,000 work-related eye injuries and approximately 750,000 work-related hand injuries requiring medical attention are reported. It is estimated that in 80% of the reported cases the injury is sustained by a person not wearing appropriate protective clothing or articles, such as safety helmets, gloves, face shields, boots and so forth (see: http://www.preventblindness.org/ten-ways-prevent-eye-injuries-work, http://www.nietc.org/safety-news-archive/121-safety-article-1.html and http://www.ishn.com/articles/94029-drive-home-the-value-of-gloves-hand-injuries-send-a-million-workers-to-ers-each-year). There is, beyond the obvious personal impact resulting from such injuries, a significant medical cost associated with injury treatment. It is, therefore, highly desirable to reduce the number of reported workplace injuries by improving the precautionary safety measures taken by workplace personnel as they operate in hazardous work environments.

### SUMMARY OF THE DISCLOSURE

The following paragraphs are intended to introduce the reader to the more detailed description that follows and not to define or limit the claimed subject matter of the present disclosure.

The present disclosure generally relates to a system and process for monitoring use of personal protective equipment (PPE). Accordingly, the present disclosure provides, in at least one aspect, an implementation of a system for automatic monitoring of the use of personal protective equipment, the system comprising:
a plurality of personal protective instruments, each personal protective instrument comprising a PPE beacon configured to transmit a wireless PPE beacon signal;
a plurality of wearable electronic detection devices, each wearable electronic detection device being associated with at least one of the personal protective instruments worn by a given user, each wearable electronic detection device being configured to:
   receive and measure at least one wireless PPE beacon signal transmitted by the at least one associated PPE beacon; determine at least one distance-based measure representing the distance between the wearable electronic detection device and the associated at least one personal protective instrument; and for the given user, execute at least one safety action according to safety rules data when the determined at least one distance-based measure between the given user's wearable electronic detection device and the at least one of the associated personal protective instruments exceeds minimal distance-based criteria; and
a central controller configured to send controlling data including safety rules data to the wearable electronic detection devices to configure the operation of the system according to centralized safety rules.

In some implementations, the wearable electronic detection device is configured to detect at least one received signal strength (RSS) level of the at least one PPE beacon signal, compare the at least one detected RSS level to an acceptable RSS level and execute a safety action when the at least one received RSS level is less than the acceptable RSS level.

In some implementations, the wearable electronic detection device is configured to detect a plurality of received signal strength (RSS) levels of the at least one PPE beacon signal, and to perform the at least one safety action when a proportion of the detected RSS levels is less than a proportion threshold.

In some implementations, the wearable electronic detection device is configured to determine a time difference between transmitting a query signal to the at least one PPE beacon and receiving a response signal from the at least one PPE beacon and to perform the at least one safety action when the time difference is larger than a time difference threshold.

In some implementations, the wearable electronic detection device is configured to repeatedly determine a time difference between transmitting a query signal to the at least one PPE beacon and receiving a response signal from the at least one PPE beacon and to perform the at least one safety action when a percentage of the repeatedly determined time differences is larger than a time separation threshold.

In some implementations, there are a plurality of thresholds with each threshold being associated with a successively larger distance and the at least one safety action has a larger intensity when a threshold associated with a larger distance is exceeded.

In some implementations, at least one of the PPE beacons comprises an integration point to a sensor on the at least one associated personal protective instrument for determining a health status of the at least one personal protective instrument and sending corresponding health status data to the associated wearable electronic detection device.

The wearable electronic detection device is generally configured to send compliance data to the central controller.

In some implementations, the compliance data comprises at least one of data on whether a safety rule was violated, what safety rule was violated, how the safety rule was violated, how long the safety rule violation occurred, how the safety violation was resolved and the location of the safety violation.

In some implementations, the wearable electronic detection device is configured with a GPS integrated circuit or a WiFi integrated circuit to determine it is located at or within a given workspace.

In some implementations, the system further comprises a control point (CP) associated with a workspace, the control point comprising a CP beacon that emits a CP beacon signal indicating the associated workspace and the wearable electronic detection device being configured to detect the CP beacon signal, determine the associated workplace and use safety rules that correspond to the associated workspace.

In some implementations, the system further comprises a control point (CP) associated with a workspace, the control having two CP beacons that are physically positioned in a spaced-apart, serial fashion adjacent or near to an entry area of the associated workspace for detecting when a workplace user with a wearable electronic detection devices enters or leaves the workspace based on the order in which the CP beacons detect the workplace user's wearable electronic detection device.

In some implementations, the control point comprises a video camera system to generate image data that is used to count the number of users at the control point and compare the number of counted users with a number of detected wearable electronic detection devices at the control point and to execute at least one safety action according to safety rules data including emitting an alert signal if the number of users does not equal the number of detected wearable electronic detection devices.

In some implementations, the control point comprises an integration point for a building access system for a workspace and when the central controller detects a violation of a safety rule, the central controller sends a control signal to maintain the workspace in a certain state until the safety rule violation is resolved.

The PPE beacons generally use one of an RFID communication protocol, a WiFi communication protocol, a BlueTooth communication protocol, a radio frequency (RF) communication protocol or a Zigbee communication protocol.

In some implementations, the wearable electronic detection device is configured to emit an alert signal to the user of the wearable electronic detection device during or after a safety rule violation.

In some implementations, the system further comprises an output device coupled to the central controller to receive operational data therefrom regarding usage of the personal protective equipment and the output device is configured to output the operational data.

In some implementations, the system further comprises a control point (CP) comprising a CP beacon configured to transmit a repeating, measurable CP beacon wireless signal and to store object data.

In some implementations, the control point is configured to transmit status data and receive the controlling data from the central controller and execute actions according to safety rules.

In some implementations, the control point comprises two CP beacons disposed in a serial fashion adjacent to an entry point that provides access to a workspace.

In some implementations, the control point comprises a video camera to record image data used to count and identify people at the entry point.

In some implementations, the control point is configured to operate in conjunction with an area security system that controls access to the monitored area.

In another aspect, a use of a system described in accordance with the teachings herein is provided to prevent or limit the incidence of accidents, incidents and/or injuries of users in a workplace.

In a further aspect, the present disclosure provides at least one implementation of an automated process for monitoring the use of personal protective equipment, the process comprising:
transmitting a plurality of wireless PPE beacon signals from a plurality of personal protective instruments used by users;
receiving at least one wireless PPE beacon signal at a wearable electronic detection device used by a user, the at least one wireless PPE beacon signal transmitted from at least one personal protective instrument used by the user and associated with the wearable electronic detection device; determining at least one distance-based measure representing the distance between the user's wearable electronic detection device and the associated at least one personal protective instrument; and
executing at least one safety action according to safety rules data when the determined at least one distance -based measure of the distance between the user's wearable electronic detection device and the user's at least one associated personal protective instrument exceeds the minimal distance-based criteria.

In at least some implementations, the user's wearable electronic detection device determines the at least one distance-based measure and performs the at least one safety action.

In at least some implementations, the process comprises using a central controller for sending controlling data including safety rules data to the wearable electronic detection devices for configuration thereof according to centralized safety rules.

In some implementations, the process comprises detecting at least one received signal strength (RSS) level of the at least one PPE beacon signal, comparing the at least one detected RSS level to an acceptable RSS level and executing the at least one safety action when the at least one received RSS level is less than the acceptable RSS level.

In some implementations, the process comprises detecting a plurality of received signal strength (RSS) levels of the at least one PPE beacon signal, performing the at least one safety action when a proportion of the detected RSS levels is less than a proportion threshold.

In some implementations, the process comprises determining a time difference between transmitting a query signal to the at least one PPE beacon and receiving a response signal from the at least one PPE beacon and performing the at least one safety action when the time difference is larger than a time difference threshold.

In some implementations, the process comprises repeatedly determining a time difference between transmitting a query signal to the at least one PPE beacon and receiving a response signal from the at least one PPE beacon and performing the at least one safety action when a percentage of the repeatedly determined time differences is larger than a time separation threshold.

In some implementations, the process comprises using a plurality of thresholds with each threshold being associated with a successively larger distance and the at least one safety action having a larger intensity when a threshold associated with a larger distance is exceeded.

In some implementations, the process comprises receiving a voltage signal from a sensor on the at least one associated personal protective instrument for determining a health status of the at least one personal protective instrument and sending corresponding health status data to the associated wearable electronic detection device.

The process generally comprises sending compliance data from the wearable electronic detection device to the central controller.

In some implementations, the process comprises using a GPS integrated circuit or a WiFi integrated circuit with the wearable electronic detection device to determine its location.

In some implementations, the process further comprises using a control point (CP) associated with a workspace, the control point comprising a CP beacon that emits a CP beacon signal indicating the associated workspace and the process comprises using the wearable electronic detection device being to detect the CP beacon signal, to determine the associated workplace and to use safety rules that correspond to the associated workspace.

In some implementations, the process comprises using a control point (CP) associated with a workspace, the control having two CP beacons that are physically positioned in a spaced-apart, serial fashion adjacent or near to an entry area of the associated workspace and the process comprises detecting when a workplace user with a wearable electronic detection devices enters or leaves the workspace based on the order in which the CP beacons detect the workplace user's wearable electronic detection device.

In some implementations, the control point comprises a video camera system for generating image data and the process comprises using the image data to count the number of users at the control point, comparing the counted users with a number of detected wearable electronic detection devices at the control point and executing at least one safety action according to safety rules data including emitting an alert signal if the number of users does not equal the number of detected wearable electronic detection devices.

In some implementations, the control point comprises an integration point for a building access system for a workspace and when the central controller detects a violation of a safety rule, the process comprises using the central controller to send a control signal to maintain the workspace in a certain state until the safety rule violation is resolved.

In some implementations, the process comprises using the wearable electronic detection device to emit an alert signal to the user of the wearable electronic detection device during or after a safety rule violation.

In some implementations, the process further comprises outputting operational data received from the central controller regarding usage of the personal protective equipment.

Other features and advantages of the present disclosure will become apparent from the following detailed description. It should be understood, however, that the detailed description, while indicating some implementations of the disclosure, are given by way of illustration only, since various changes and modifications within the spirit and scope of the disclosure will become apparent to those of skill in the art from the detailed description.

### BRIEF DESCRIPTION OF THE DRAWINGS

The disclosure is in the hereinafter provided paragraphs described, by way of example, in relation to the attached figures. The figures provided herein are provided for a better understanding of the example implementations and to show more clearly how the various implementations may be carried into effect. The figures are not intended to limit the present disclosure. It is further noted that identical numbering of elements in different figures is intended to refer the same element, possibly shown situated differently or from a different angle. Thus, by way of example only, element 115 in both FIG. 1 and FIG. 2 references the same PPE beacon.

FIG. 1 is a schematic view of a system for monitoring the use of personal protective equipment according to an example implementation of the present disclosure.

FIG. 2 is a schematic view of a configuration of certain electronic components of the system for monitoring the use of personal protective equipment according to an example implementation of the present disclosure.

FIGS. 3A and 3B is a schematic view of an aspect of the system for monitoring the use of personal protective equipment relating to the emitting of an alert signal according to an implementation of the present disclosure.

FIGS. 4A and 4B is a schematic view of another aspect of the system for monitoring the use of personal protective equipment relating to the emitting of an alert signal according to an example implementation of the present disclosure.

FIG. 5 is a schematic view of an aspect of a system and a configuration of certain electronic components of that aspect of the system for monitoring the use of personal protective equipment according to an example implementation of the present disclosure.

FIG. 6 is a schematic view of a system for monitoring the use of personal protective equipment according to another implementation of the present disclosure.

FIG. 7 is a flow chart of a process for monitoring if a safety violation has occurred for the use of personal protective equipment according to an example implementation of the present disclosure.

FIG. 8 is a flow chart of a process for initializing and configuring a central controller for monitoring the use of personal protective equipment in one or more workspaces according to an example implementation of the present disclosure.

FIG. 9 is a flow chart of a process for initializing a wearable electronic detection device that is used in monitoring the use of personal protective equipment according to an example implementation of the present disclosure.

FIG. 10 is a flow chart of a process for monitoring the use of personal protective equipment using a control point according to an example implementation of the present disclosure.

FIG. 11 is a flow chart of a process for updating controlling data at a central controller for monitoring the use of personal protective equipment according to an example implementation of the present disclosure.

FIG. 12 is a flow chart of a process for dealing with a beacon that is not identified in controlling data stored by a wearable electronic detection device according to an example implementation of the present disclosure.

### DETAILED DESCRIPTION OF THE DISCLOSURE

Various systems and processes will be described below to provide an example of an implementation or implementation of each claimed subject matter. No implementation described below limits any claimed subject matter and any claimed subject matter may cover methods, systems, devices, assemblies, processes or apparatuses that differ from those described below. The claimed subject matter is not limited to systems or processes having all of the features of any one system, method, device, apparatus, assembly or process described below or to features common to multiple or all of the systems, methods, devices, apparatuses, assemblies or processes described below. It is possible that a system or process described below is not an implementation or implementation of any claimed subject matter. Any subject matter disclosed in a system or process described below that is not claimed in this document may be the subject matter of another protective instrument, for example, a continuing patent application, and the applicants, inventors or owners do not intend to abandon, disclaim or dedicate to the public any such subject matter by its disclosure in this document.

All publications, patents and patent applications are herein incorporated by reference in their entirety to the same extent as if each individual publication, patent or patent application was specifically and individually indicated to be incorporated by reference in its entirety.

### Definitions

The terms “automated system” or “system” as used interchangeably herein, refers to a device, or configuration of a plurality of devices, with one or more electronic processing elements capable of performing machine executable instructions, including but not limited to, any server, cloud-based infrastructure, personal computer, desktop computer, hand-held computer, laptop computer, tablet computer, cell phone computer, smart phone computer or other suitable electronic device or plurality of devices.

The term “beacon” as used herein refers to refers to an electronic device, which may be an integrated circuit, with a power source capable of storing data and an antenna capable of transmitting wireless signals at one or more radio frequencies. Beacons include radio frequency based beacons that may be implemented using one or more communication techniques including WiFi, Bluetooth® and Zigbee®. In some implementations, a beacon may comprise an active or passive radio frequency identification (RFID) device or tag, or transponder.

The beacon can electronically store and transmit object data, including but not limited to a unique identifier and optionally payload (i.e. battery life). In some implementations, the object data may also include sensor data, such as from impact sensors, and include, for example, impact data if an impact sensor were mounted on a hard hat. Accordingly, the sensor data includes data on the operational status (i.e. health status) of the corresponding personal protective instrument in terms of whether it has encountered a physical event, such as a physical impact, and whether it is still able to operate properly. The health status data can be sent to the wearable electronic detection device that is associated with the personal protective instrument. The configuration of the data items that can be encoded in the object data is entered into the central controller to represent information associated with a particular beacon. For example, the object data transmitted from a PPE beacon can be associated with one or more of the type and age of the personal protective instrument (e.g. hard hat), the user to which it is assigned, and what the sensor data refers to (e.g. impact to hard hat). In the case of a control point (CP) beacon (a control point is defined later below), the unique identifier it transmits can be associated with including but not limited to the location of the control point.

The term “compliance data” as used herein refers to data relating to the relative distance of a PPE beacon to a wearable electronic detection device. The wearable electronic detection device is configured to determine the distance between the PPE beacon and a wearable electronic detection device. This is stored as distance data which is then analyzed by the wearable electronic detection device to determine compliance data regarding the use of personal protective instruments by a user who uses the wearable electronic detection device and the personal protective instruments based on safety rules. This compliance data includes but is not limited to whether a safety rule was violated, what safety rule was violated, how it was violated, how long the violation lasted, how the violation was resolved and, in some implementations of the system, the location of the violation. This compliance data is transmitted by the wearable electronic detection device to the central controller.

The term “controlling data” as used herein refers to data that can be configured at the central controller and transmitted by the central controller to the wearable electronic detection devices or, in some implementations, the control points in a particular system. The controlling data includes, but is not limited to data regarding users, devices (e.g. wearable electronic detection devices, beacons, and control points), workspaces, safety rules and executable actions. The term “safety rules data”, as used herein, refers to criteria, that when met will prompt the wearable electronic detection device, the central controller, or in some implementations the control point, to execute actions that are specified by the safety rules data. For example, the safety rule data can include a safety rule distance, a safety rule time and a safety rule action that are defined such that if a user is separated from their personal protective instrument by more than 2 meters (i.e. the safety rule distance) for longer than 30 seconds (i.e. the safety rule time), the wearable electronic device will execute the safety rule action associated with that safety rule, which may be to generate and emit an alert signal. Executable safety rule actions include, but are not limited to, alert actions (e.g. audible, visual, and or tactile alerts) and operational actions (e.g. communicating with the central controller, sending of emails, and/or logging of data).

The term “coupled” as used herein can have several different meanings depending on the context in which the term is used. For example, the term coupled can have a mechanical or electrical connotation depending on the context in which it is used, i.e. whether describing a physical layout or transmission of data as the case may be. For example, depending on the context, the term coupled may indicate that two elements or devices can be directly physically or electrically connected to one another or connected to one another through one or more intermediate elements or devices via a physical or electrical element such as, but not limited to, a wire, wireless, a non-active circuit element (e.g. resistor) and the like, for example.

The term “output device” as used herein refers to any device that is used to output information and includes, but is not limited to, one or more of a terminal, a desktop computer, a laptop, a tablet, a cellular phone, a smartphone, a printer (e.g. laser, inkjet, dot matrix), a plotter or other hard copy output device, speaker, headphones, electronic storage device, a radio or other communication device, that can communicate with another device, or any other computing unit. Output devices may comprise a two dimensional display, such as a television or a liquid crystal display (LCD), a light-emitting diode (LED) backlit display, a mobile telephone display, and/or a three dimensional display capable of providing output data in a user viewable format.

The terms “personal protective equipment” (PPE) and “personal protective instrument” as used herein, refers to any equipment, instrument or article capable of reducing the risk of injuries or bodily damage to a person, e.g. eye injuries, hand injuries, foot injuries and other forms of bodily harm, as a result of incidents, accidents and/or injuries including incidents in a workplace including, without limitation, a safety helmet, safety gloves, safety glasses or safety goggles, safety footwear, a face shield or face mask, hearing protection devices, a protective vest or protective jacket, a safety suit or safety gown, a gas tank and/or breathing apparatus, a radiation dosimetry device, and safety footwear. These terms are further intended to include protective gear worn in workplaces where there are risks of contamination of work objects by direct human contact with such objects, such as protective articles and instruments used in, for example, electronics manufacturing, or pharmaceutical or biologics manufacturing.

The term “status data” as used herein can generally refer to data transmitted to the central controller about the status of a particular device or workspace. For example, status data can be related to the status of a PPE or a wearable electronic detection device. This status data can be referred to as PPE status data and wearable electronic detection device status data. Alternatively, in implementations which include a control point, the status data can be referred to as control point status data and include, but is not limited to, one of more of the number of wearable electronic detection devices, the number of users, a list of detected PPE beacons, and images or video data.

It should be noted that terms of degree such as “substantially”, “about” and “approximately” as used herein mean a reasonable amount of deviation of the modified term such that the end result is not significantly changed. These terms of degree should be construed as including a deviation of the modified term if this deviation does not negate the meaning of the term it modifies.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

### General Implementation of the System

As hereinbefore mentioned, in one aspect, the present disclosure relates to systems and processes for automated monitoring the use of personal protective equipment. The automated system and processes can be implemented in a manner that fosters strong compliance with the safety regulations and guidelines applicable in a workspace, such as in a hazardous work environment. The system may be configured to accurately monitor and ascertain whether a person is wearing one or more personal protective instruments in accordance with controlling information that may be defined in various ways, such as safety rules for a particular work environment.

In another aspect, at least one implementation of the systems of the present disclosure is sufficiently sensitive to readily detect a brief period of time separation between a user and a personal protective instrument (for example, 10 seconds or less) and/or a physical separation between a user and the personal protective equipment across a short distance (for example, 1 m or less). Furthermore, operation of the system does not require the permanent installation of fixed wireless signal readers that are fixed at a certain location to determine PPE use compliance within a workspace, which is very cumbersome to ensure all areas within a large workspace are covered as this requires multiple fixed wireless signal readers according to conventional technology. Also with fixed wireless signals readers, there can be obstructions between the fixed reader and the beacons.

In contrast and advantageously, the herein disclosed systems, therefore, are suitable for flexible use in many environments, including rapidly altering or temporary workspaces, such as construction sites and do not suffer from any blocking situations as a wearable electronic detection device is carried by the user and is in communication with PPE beacons to determine if a safety violation has occurred. The processes and system are free of fixed wireless signal readers and do not involve the use of transducer-type sensors, such as photoelectric sensors or pressure sensors, to monitor whether protective equipment is worn by a user. Thus, the system is not susceptible to sensor malfunction or sensitive to slight adjustments a user wearing the equipment may make from time to time, or external factors such as weather, all of which may interfere with functioning of sensors and generate false alarms. The system also does not require custom fitting as may be required for sensor-based systems. These and other beneficial aspects, render the herein disclosed system useful in preventing the occurrence of work related injuries.

Accordingly, the present disclosure provides, in at least one aspect, an implementation of a system for automatic monitoring the use of personal protective equipment, the system comprising:
a plurality of personal protective instruments, each personal protective instrument comprising a PPE beacon configured to transmit a wireless PPE beacon signal;
a plurality of wearable electronic detection devices, each wearable electronic detection device being associated with at least one of the personal protective instruments worn by a given user, each wearable electronic detection device being configured to:
   receive and measure at least one wireless PPE beacon signal transmitted by the at least one associated PPE beacon; determine at least one distance-based measure representing the distance between the wearable electronic detection device and the associated at least one personal protective instrument; and for the given user, execute at least one safety action according to safety rules data when the determined at least one distance-based measure between the given user's wearable electronic detection device and the at least one of the associated personal protective instruments exceeds minimal distance-based criteria; and
a central controller configured to send controlling data including safety rules data to the wearable electronic detection devices to configure the operation of the system according to centralized safety rules.

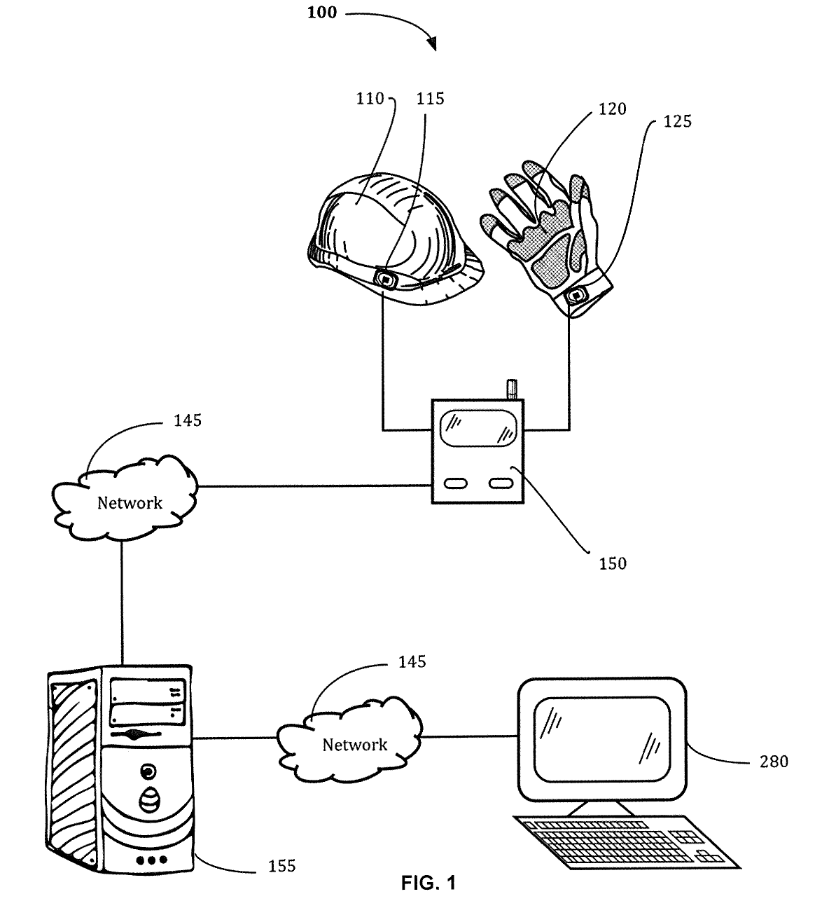

An example implementation of a system for automatic monitoring the use of personal protective equipment according to the present disclosure is shown in FIG. 1. Thus referring now to FIG. 1, the present disclosure provides, in an example implementation, a system 100 for monitoring use of personal protective equipment, the system 100 comprising a plurality of personal protective instruments, examples of which are a safety helmet 110 and a safety glove 120, and a wearable electronic detection device 150. Other personal protective instruments, including, without limitation, safety footwear, safety vests, safety jackets, safety suits, safety goggles, safety masks, hearing protection devices (not shown) may, additionally or alternatively, be part of the here disclosed system 100. Each of the personal protective instruments 110, 120 is separately tagged, permanently or detachably, with PPE beacons 115, 125, respectively, by adhering or attaching the PPE beacons 115, 125 to the personal protective instruments 110, 120. In some implementations, the PPE beacons 115, 125 may be implemented using RFID, Bluetooth®, or ZigBee® communication.

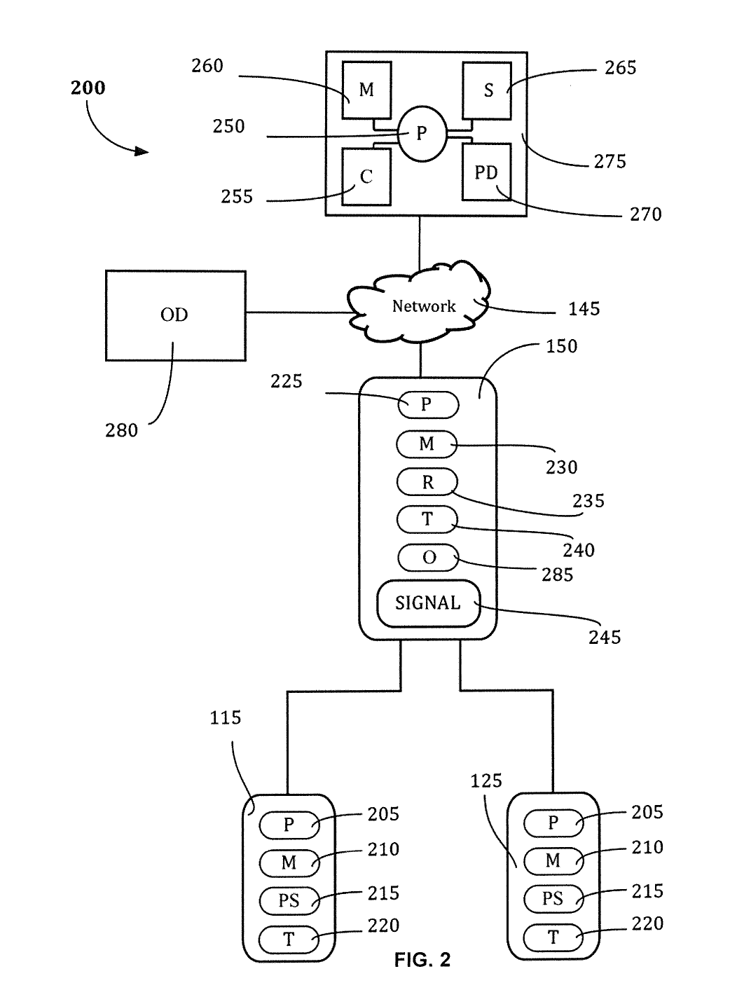

Referring now to FIG. 2, the PPE beacons 115, 125 comprise a processor component 205, a memory component 210, a power source component 215 and a transmitter component 220, such as an antenna and optionally associated circuitry, for transmitting a radio signal to the wearable electronic detection device 150. Other components (not shown) used in the operation of the PPE beacons 115, 125 may be included as is known by those skilled in the art of beacons. The memory component 210, e.g. a non-volatile memory component, is configured to receive and electronically store object data 110, 120. The memory component 210 of the PPE beacons 115, 125 stores the unique identifier associated with the PPE beacons 115, 125, which permits unique identification of a personal protective instrument.

In some implementations, a PPE beacon can comprise an integration point, i.e. a wired connection, to a sensor that can be used to perform measurements or detect certain events (such as an impact) that impacts the PPE health (i.e. PPE status). For example, an impact sensor (not shown) can be mounted on a hard hat. If the impact sensor was triggered, it can send a voltage signal to the PPE beacon through the integration point. The PPE beacon can include that signal in the object data that is in the wireless PPE beacon signal that it transmits to the corresponding wearable electronic detection device. The wearable electronic detection device can then transmit the object data to the central controller and execute safety rule actions based on safety rules in the controlling data.

The processor component 205 is used to control the operation of the transmitter component 220 of the PPE beacons 115, 125 as well as the memory component 210. It is noted that in some implementations, the PPE beacon may be a passive beacon, i.e. it may include an RFID tag that does not include a power source, and includes a receiver component. In other implementations, the PPE beacon may include an active PPE beacon, i.e. an RFID tag including a power source, such as a battery, which may be activated by an external device (battery assist-passive), notably by the wearable electronic detection device 150. In such implementations, the processor component 205 may further be used to modulate and de-modulate a radio-frequency signal.

Referring again to FIG. 1, the system 100 further comprises a wearable electronic detection device 150. The wearable electronic detection device 150, in accordance with the teachings herein, is a portable device that is carried, wearable, or worn by an individual user, such as a lightweight handheld device, and may for example, conveniently, be a bracelet, a band, or a clip-on device to be attached to, for example, a belt, or other article worn by a user or one of the user's body parts, or inserted in a pocket of the garments of a user. In an alternative implementation, the wearable electronic detection device 150 may be integrated in another portable device, for example a telephone (e.g. a cellular phone) or smartphone, electronic wristwatch or wrist-phone.

In accordance herewith, the wearable electronic detection device 150 is associated with or corresponds with the PPE beacons 115 and 125 of the protective equipment instruments 110 and 125, respectively, since they are currently being used by the same user. This association means that the wearable electronic detection device 150 is configured to receive wireless PPE beacon signals from the PPE beacons 115, 125. Also the wearable electronic detection device 150 can perform certain measurements such as distance and time measurements with respect to the associated PPE beacons 115 and 125 as is described in further detail below. The wearable electronic device 150 is further coupled to a central controller 155 via a wireless communication network 145, and capable of communicating with the central controller 155.

Referring to FIG. 2, the wearable electronic detection device 150 comprises a processor component 225, a memory component 230, a signaling component 245, and an output component 285. The memory component 230 is a read/write memory component, capable of receiving and electronically storing data. Such data includes controlling data received from the central controller 155. In some implementations, such data further includes, without limitation, one or more of personal user data relating to a worker, such as, at least one of name, employee number, position in an organization, worker qualifications, including, for example, safety qualifications, and other information deemed relevant to the work environment in which the system is operating.

Further, the memory component 230 stores and runs a software application that communicates with the central controller 155 via a WiFi integrated circuit and antenna any time it detects a network connection. When the wearable electronic detection device 150 is in communication with the central controller 155, the software application uploads data including but not limited to one or more of compliance data, location data, wearable electronic detection device status data, and PPE beacon status data and downloads data including but not limited to one or more of controlling data including safety rule data updates. The software application interprets the safety rules data and executes the safety rule actions defined by the safety rules (e.g. alerts).

In some implementations, the wearable electronic detection device 150 also comprises a global positioning system (GPS) integrated circuit and antenna to enable location awareness in outdoor workspaces by receiving GPS signals from satellites. Accordingly, this implementation does not require a control point if the users have wearable electronic detection devices.

In some implementations, the wearable electronic detection device 150 comprises a WiFi integrated circuit to enable location awareness in a workspace using a wireless mesh network. The wireless mesh network comprises WiFi Access Points deployed throughout the workspace, Wireless Local Area Network (LAN) Controllers to control the individual WiFi Access Points, and a Wireless Location Appliance that communications with the individual WiFi Access Points to determine the distance from each one to the wearable electronic detection device, and thereby triangulate the location of the wearable electronic detection device. The wearable electronic detection device, or the central controller, can communicate with the Wireless Location Appliance to get the location of the wearable electronic detection device. For example, each access point is updating the Wireless LAN Controllers with the RSS from the wearable electronic detection device. The Wireless Location Appliance receives the RSS information from the Wireless LAN Controllers, plus the location of each WiFi Access Point that provided an RSS, to then perform a calculation to triangulate the location of the wearable electronic detection device. It will provide this location to either the wearable electronic detection device or the central controller when they request it from the Wireless Location Appliance via the wireless network.

The wearable electronic detection device 150 further comprises a receiver component 235, and a transmitter component 240, such as an antenna, for receiving and transmitting, respectively, a radio signal to (e.g. if the PPE beacon is an RFID tag) and from the PPE beacons 115, 125. The processor component 225 is used to control the receiver component 235 and the transmitter component 240 of the wearable electronic detection device 150. When multiple PPE beacons are used, such as when, for example, PPE beacons 115 and 125, associated with the safety helmet 110 and the safety glove 120, respectively, are used by a single user, the PPE beacons 115 and 125 emit signals containing unique identifiers so that the wearable electronic detection device 150 can separately detect and identify the PPE beacons 115 and 125 separately to verify that the user, in this example, is using both the safety helmet 110 and the safety gloves 120.

The wearable electronic detection device 150 further is configured to receive and measure the wireless PPE beacon signals transmitted by the associated PPE beacons to determine at least one distance-based measure representing the distance between the wearable electronic detection device 150 and the associated PPE beacons 115, 125. The wearable electronic detection device 150 can then execute at least one safety action according to safety rules data when the determined at least one distance-based measure between the wearable electronic detection device 150 and at least one of the associated personal protective instruments exceeds minimal distance-based criteria.

For example, repeated signaling at a certain interval, such as on the order of milliseconds or seconds, by the PPE beacons 115, 125, can be used to establish their location relative to the wearable electronic detection device 150, on a more or less continuous basis. For example, in some implementations, the PPE beacon signal interval is preconfigured by the manufacturer (e.g. Bluetooth® beacon). The signaling by the PPE beacons 115, 125 and the acts of determining the distance and monitoring the distance between the wearable electronic detection device 150 and the PPE beacons 115, 125 may be performed in several ways.

In one example implementation, the wearable electronic detection device 150 is configured to detect at least one received signal strength (RSS) level of the PPE beacon signal, which decreases as a function of the relative distance between the wearable electronic detection device 150 and the PPE beacons 115, 125 (e.g. Bluetooth® beacons). The software application stored and running on the wearable electronic detection device 150 measures the signal strength and compares it to the configured acceptable RSS level for each PPE beacon 115, 125. If the RSS decreases below the configured acceptable RSS level, the software application stored and running on the wearable electronic detection device 150 executes actions according to the safety rules data. In other implementations, the software application stored and running on the wearable electronic detection device 150 may be used to perform alternative measurements and alternative distance related evaluations to determine if a safety rule has been violated.

In an alternative implementation, in addition to the above monitoring, the wearable electronic detection device 150 may be configured to store a plurality of detected RSS values (i.e. RSS levels) and a trending analysis of the stored RSS values may be performed, for example, by the wearable electronic detection device 150 and/or the central controller 155. An action according to the safety rules data, for example emitting an alert signal, is executed by the wearable electronic detection device 150 when a significant number of detected RSS values within a defined time period is sufficiently low compared to a threshold, such as a preconfigured acceptable RSS value(or in other words when a proportion of the detected RSS levels is less than a proportion threshold), for example, to indicate that the physical separation between the wearable electronic detection device 150 and the PPE beacons 115, 125 is more than what is defined as acceptable in the safety rules. These thresholds can be predetermined based on making measurements under different experimental situations. This implementation permits corrections in the event of loss of signal strength caused by events other than increased physical separation of the wearable electronic detection device 150 and the PPE beacons 115, 125, for example, as a result of signal attenuation, multi-path reflection, and signal obstruction by objects temporarily positioned between the wearable electronic detection device 150 and PPE beacons 115, 125.

In some example implementations, in order for the wearable electronic detection device to detect the RSS, the wearable electronic detection device may be equipped with a Bluetooth® integrated circuit comprising an antenna or a WiFi integrated circuit comprising an antenna.

In another example implementation, the wearable electronic detection device 150 is configured to detect the time difference between a transmitted query signal to the PPE beacon and a received response signal from the PPE beacon. For example, the wearable electronic detection device 150 may be configured to emit a signal which is received and processed by PPE beacons 115, 125 (e.g. RFID tags) and subsequently retransmitted to the wearable electronic detection device 150. Accordingly, in these implementations, the PPE beacons 115 and 125 also comprise a receiver (or a transceiver instead of a separate transmitter and receiver) for receiving and transmitting signals. The duration of time between emitting a signal and receipt of the signal by the wearable electronic detection device 150 from each of the PPE beacons 115, 125 is determined by the software application stored and running on the wearable electronic detection device 150. Upon the duration of time exceeding a configured acceptable value (i.e. a time difference threshold) corresponding with separation of the wearable electronic detection device 150 and any of the PPE beacons 115, 125, the software application stored and running on the wearable electronic detection device 150 executes actions according to the safety rules data.

In an alternative example implementation, in addition to the above time determination, the wearable electronic detection device 150 may be further configured to store a plurality of detected time difference values and perform a trending analysis of the stored time difference values. An action according to safety rules data, for example emitting an alert signal, is executed by the wearable electronic detection device 150 when a significant number of stored duration-of-time values within a defined time period is sufficiently long, for example, relative to a baseline duration-of-time value (or in other words when a percentage of the repeatedly determined time differences is larger than a time separation threshold, to indicate that there is unacceptable separation between the wearable electronic detection device 150 and the PPE beacons 115, 125. The foregoing allows correction in the event of a brief period of separation between the wearable electronic detection device 150 and the PPE beacons 115, 125, as explained previously. For example, a safety rule can be configured on the central controller 155 that states that if a user is in a workspace, and the distance between the user's wearable electronic detection device and one of the associated PPEs for a personal equipment instrument used by the user is greater than a distance limit for greater than a time limit (e.g. the distance is greater than 1 meter for more than 30 seconds), the wearable electronic detection device is to generate an alert signal such as a vibration signal and display a message on its display identifying the PPE that is uncompliant and when in contact with the central controller, log the violation details. The distance may be determined by using a Bluetooth beacon standard that has a predefined function that converts a measured RSS level to a distance between the PPE beacon and the wearable electronic detection device. The distance limit and time limit in the safety rule can be adjusted based on the industry and the environment (higher risk environments might require a shorter distance and a shorter time) in which the user is working.

In some example implementations, in order for the wearable electronic detection device 150 to detect these time differences the wearable electronic detection device 150 may be equipped with an RFID transceiver.

It is noted that the foregoing features and the ability to enter customized safety rules for both the time and distance at the central controller 155 for use in the automated safety system allows for a very brief separation of the personal protective equipment and the user and/or separation across a minimal distance and/or minimal time, for example, to adjust fitting of safety equipment, without generating an alert signal. Thus, the system may tolerate adjustment of a helmet or safety glasses. Accordingly, the central controller 155 allows for the configuration of centralized safety rules.

In some example implementations, one or more of the foregoing methodologies are combined to detect the relative positions of the wearable electronic detection device 150 and the PPE beacons 115, 125.

The distance between the wearable electronic detection device 150 and the PPE beacons 115, 125 is determined via wireless signals. Wireless signals that may be used in accordance herewith are wireless signals suitable to conduct information over short distances, e.g. less than 10 meters, less than 5 meters, less than 2 meters, less than 1 meter, and may operate at for example between 1.5 MHz and 4 MHz, or any other suitable frequency range, and require limited use of power, including, for example, Bluetooth®, RFID, Zigbee® or any other local area wireless signaling system.

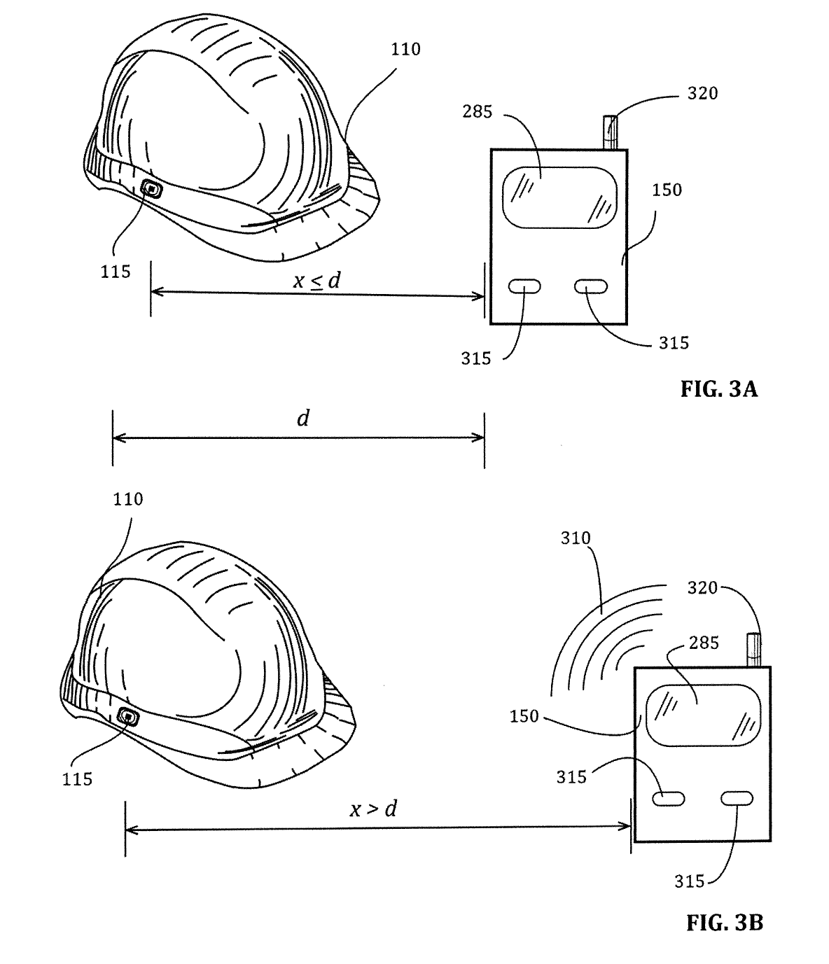

In accordance herewith, the wearable electronic detection device 150 is configured to execute actions based on safety rules data, such as activate the signaling component 245, when the distance between one or more of the PPE beacons 115, 125 and the wearable electronic detection device 150 exceeds a minimal signaling distance or in some cases the distance between one or more of the PPE beacons 115, 125 and the wearable electronic detection device 150 exceeds a minimal signaling distance for a certain period of time. Thus, referring to FIG. 3A and 3B, when the distance x between the wearable electronic detection device 150 of a given user and the safety helmet 110 is equal to or smaller than a predefined minimal signaling distance d, the wearable electronic detection device 150 does not emit an alert signal (FIG. 3A). However when the distance x exceeds the minimal signaling distance d, the wearable electronic detection device 150 of a given user emits an alert signal 310 (FIG. 3B). Thus, for example, when a given user having the wearable electronic detection device 150 attached to his or her belt and wearing safety helmet 110, removes the helmet from his or her head, separating himself or herself from the helmet 110, the wearable electronic detection device emits an alert signal 310.

The minimal signaling distance d may be set as desirable, and may, for example, be 25 cm or about 25 cm; 50 cm or about 50 cm; 1 m or about 1 m; 1.50 m or about 1.50 m; or 2 m or about 2 m. Furthermore, minimal signaling distances d may be defined using the central controller 155 to include different values for different personal protective instruments. Thus, for example, the minimal signaling distance d for safety boots may be different from the minimal signaling distance d for a safety mask. The minimal signaling distance d may be defined by an operator of the system 100 using an input device associated with or coupled to the central controller 155 (FIG. 1), and then the minimal signaling distance d can be transmitted in the controlling data that is sent from the central controller 155 through the network 145.

In some example implementations, the signaling component 245 of the wearable electronic detection device 150 is capable of emitting a range of different alert signals 310, for example, a sound signal, a light signal, a vibrational signal, a heat signal or a combination thereof or any other detectable alert signal. Referring to FIG. 3B, in some implementations, the wearable electronic detection device 150 comprises an output device, for example, a display 285 such as a liquid crystal display (LCD) or a light-emitting diode (LED) backlit display capable of signaling to a user that the minimal signaling distance d has been exceeded. In accordance herewith, compliance information relating to the emitted alert signal 310 is also transmitted to the central controller 155 (FIG. 1) for further processing, as hereinafter described.

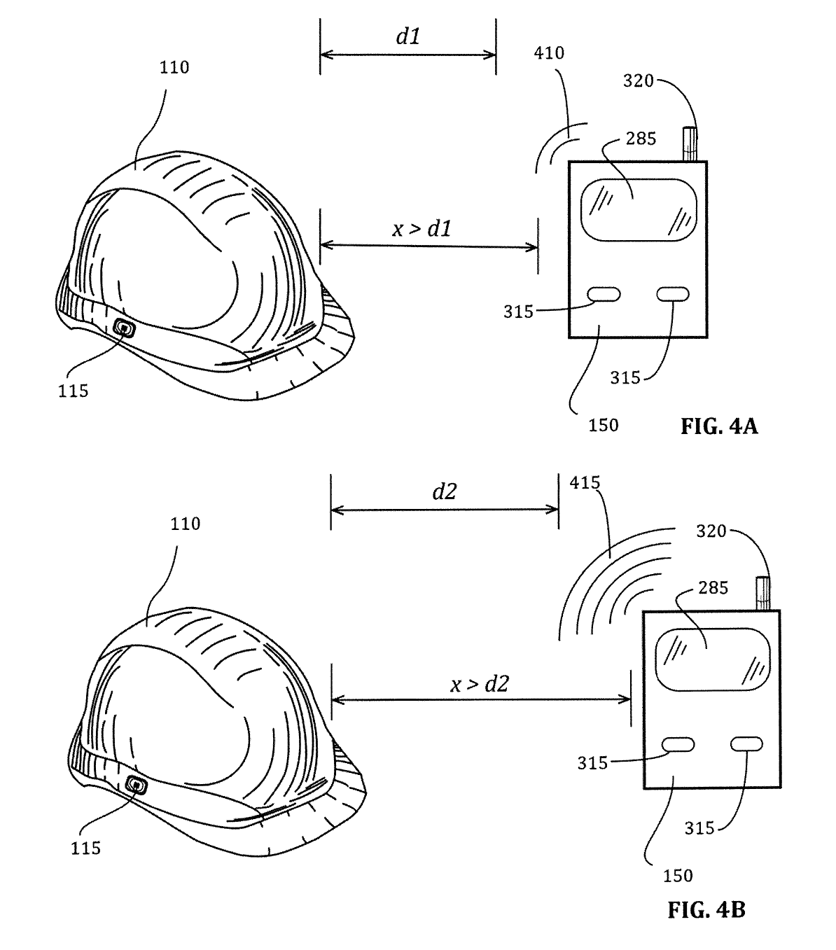

In some implementations, the wearable electronic detection device 150 is configured to refer to a plurality of minimal distance thresholds, e.g. d1, d2, d3, d4, wherein exceeding each minimal signaling distance, results in the wearable electronic detection device 150 emitting a different alert signal and/or an alert signal of a different intensity. Accordingly, there can be a plurality of thresholds with each threshold being associated with a successively larger distance and the safety action has an alert signal with a larger intensity when a threshold associated with a larger distance is exceeded. Thus, referring to FIGS. 4A and 4B, as a user removes his or her safety helmet 110, and moves away from the safety helmet 110, the wearable electronic detection device 150 emits a sound signal 410, e.g. when the user becomes separated by a distance in excess of distance d1 from the safety helmet 110 (FIG. 4A). As the user continues to move further away from the helmet 110, and becomes separated from the helmet by a distance d2, the wearable electronic detection device 150 emits a louder sound signal 415 (FIG. 4B).

Thus, in at least one implementation of the system of the present disclosure, detection of separation of personal protective instruments from an individual user is permitted, even if such separation occurs for a relatively brief period of time, for example less than 30 seconds, 20 seconds, or 10 seconds and/or when the separation distance is relatively small, e.g. less than 2 m, less than 1 m, or less than 50 cm, providing, therefore, an effective way of assessing compliance and providing protection for the user.

The wearable electronic detection device 150, in some implementations, additionally comprises input components 315 (FIG. 3B), for example, for silencing an emitted audio signal 310, or, for example, to provide input data to the memory component 230 (FIG. 2) such as, for example, user data. In such implementations, some or all of the input components 315 may be configured to work with a control access module (not shown) requiring a user of the wearable electronic detection device 150 to provide a certain input data using the input components 315 to present, such as, but not limited to, for example a login or a password to confirm that the user of the input components 315 is authorized to provide an input to the wearable electronic detection device 150. The control access module may be implemented using software. The input components 315 may comprise various types of interfaces, such as, but not limited to, one or more knobs or buttons, or in other implementations, may comprise a keyboard, or screen, e.g. an liquid crystal display (LCD) or a light-emitting diode (LED) backlit display. In other implementations, input to the wearable electronic detection device 150 is provided via a separate input device, e.g. a desktop computer, a laptop computer, a telephone (e.g. a cellular phone), a tablet, a voice recognition system, or the like, using a wireless or wired network coupling the separate input device and the wearable electronic detection device 150. Such separate input devices, in some implementations, also may be configured to comprise a control access module that operates as described for the wearable electronic detection device 150.

The wearable electronic detection device 150 is further configured to transmit data that includes but is not limited to compliance data, possibly PPE status data and possibly wearable electronic detection device status data to the central controller 155. The compliance data includes but is not limited to distance data relating to the relative distance of the PPE beacons 115, 125 to the wearable electronic detection device 150, user safety data indicating whether a safety rule was violated, what safety rule was violated, how it was violated, how long the violation lasted, how the violation was resolved and, in some implementations of the system, the location of the violation.

In implementations which incorporate one or more control points, the wearable electronic detection device 150 can also be configured to transmit the PPE status data and/or the wearable electronic detection device status data when the user that uses the wearable electronic detection device 150 passes by a control point and either enters or exits a workspace or safety zone associated with the control point and is being monitored to make sure that workers are abiding by the safety rules defined for that workspace. The PPE beacon and wearable electronic detection device status data may include battery status or battery levels or any operational errors that have occurred for the PPE beacons and wearable electronic detection devices, for example. In implementations where a sensor is integrated into a personal protection instrument having a PPE beacon, the PPE status data can include measurements made by the sensor on the health/operability of the personal protection instrument.

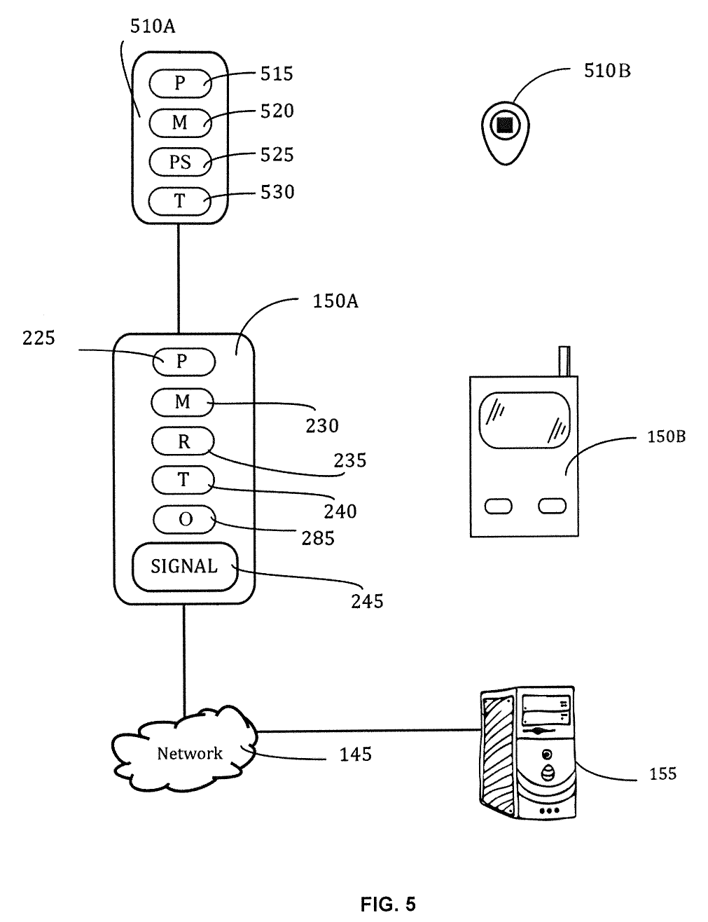

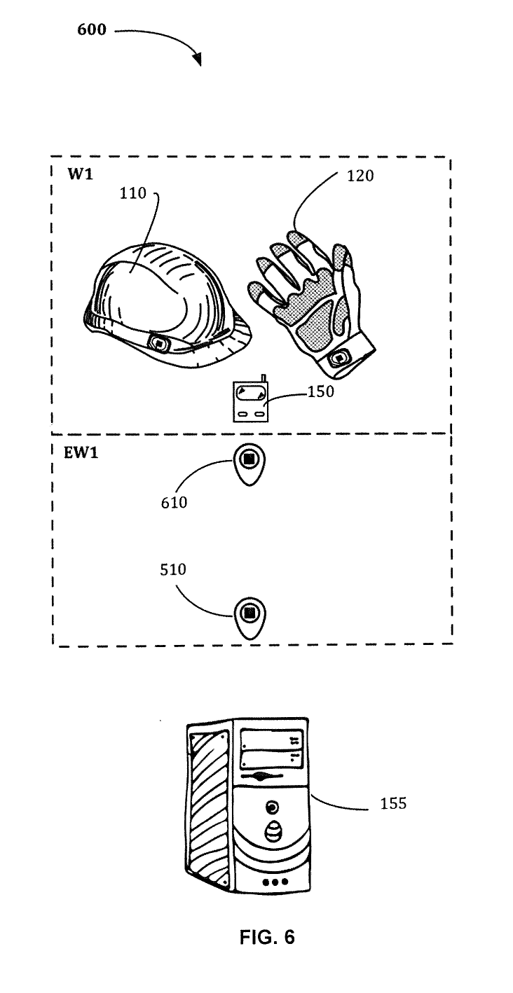

Referring again to FIG. 1 again, the system 100 further comprises a central controller 155 configured to receive compliance data from the wearable electronic detection devices 150 that is operably coupled to the network 145 via communication components, such as a WiFi integrated circuit and an antenna. The central controller 155 is configured to provide an indication, such as a report or to maintain a database, regarding the use of the personal protective equipment, and can perform data logging of all users, wearable electronic detection devices, PPE beacons and control points (if included) in the system 100. The central controller 155 controls the entire operation of the system 100. Accordingly, an operator can define controlling data that the central controller 155 uses to control the system 100. The central controller 155 further may be configured to receive and store object data from the PPE beacons 115, 125, and/or to receive and/or store compliance data from the wearable electronic detection device 150, and/or store to receive and/or store status data including PPE status data, wearable electronic detection device status data and control point status data (if the system 100 has one or more control points) and/or transmit controlling data to the wearable electronic detection device 150, and in some implementations, to a control point (which is described further in relation to FIG. 5 and FIG. 6 below). Thus, in some example implementations, the present disclosure further comprises an electronic central controller 155 capable of controlling a system for automatic monitoring of the use of personal protective equipment comprising:
a plurality of personal protective instruments, each personal protective instrument comprising a PPE beacon configured to transmit a wireless PPE beacon signal;
a plurality of wearable electronic detection devices, each wearable electronic detection device associated with one or more personal protective instruments used by a user and each wearable electronic detection device being configured to receive and measure at least one wireless PPE beacon signal transmitted by the at least one associated PPE beacon; determine at least one distance-based measure representing the distance between the wearable electronic detection device and the associated at least one personal protective instrument; and for the given user, execute at least one safety action according to safety rules data when the determined at least one distance-based measure between the given user's wearable electronic detection device and the at least one of the associated personal protective instruments exceeds minimal distance-based criteria.

Referring again to FIG. 2, there is shown an implementation of a system 200 wherein the functionality of the central controller 155 is implemented by a computer server 275 configured to implement at least one of the processes of the present disclosure. The computer server 275 comprises a central processing unit (CPU, also referred to as “processor”) 250, which may be a single core or multi-core processor, or a plurality of processors. The computer server 275 further includes a memory component 260 (e.g. a random-access memory, read-only memory, flash memory), electronic storage device or devices (e.g. a hard disk or a cloud-based infrastructure) 265, a communication interface 255, which may comprise an input interface, an output interface and a network interface (for example, a radio), for communicating with one or more wearable electronic detection devices 150, and one or more peripheral devices 270, such as cache, other memory, data storage etc. The processor component 250 is in communication with the memory component 260, the electronic storage device 265, the communication interface 255 and the peripheral devices 270.

In accordance with one aspect hereof, the output device 280 of the central controller 155 of the system of the present disclosure is configured to provide an indication regarding the use of the personal protective equipment and possibly other components of the safety system. For example, it may provide reporting on details of the locations, users, and devices configured that are using the safety system, included but not limited to, one or more of role data, status data, function data, location data, operational data (which may include data on the usage of the personal protective equipment), changes made, an audit log, and compliance history. For instance, an example implementation is to run a report on a given workspace to provide all the safety violations during a given time period (e.g. a month) and detail the users experiencing the safety violations and the time period required to resolve safety violations. In another example implementation, a report can be run to provide a list of all of the PPE devices entered in the safety system which is cross-referenced with the last time each PPE was present in the workspace.

In another example implementation, a report can be run on all of the users entered in the safety system and the average number of violations incurred for a given time period, such as each month, for these users. In another example implementation, a report can be run auditing/indicating which changes have been made to the safety rules over a period of time, e.g. a year and the users who made these changes. In another example implementation, a report can be run showing a history of control point violations, for example, which control point displayed the best compliance versus which control point displayed the most safety violations thus allowing a determination of whether actions need be taken to increase compliance at the control point that experienced more safety violations. Accordingly, the central controller 155 is configured to receive compliance data from one or more of the wearable electronic detection devices, process the received compliance data and analyze the processed compliance data or provide the processed compliance data to another device, such as a laptop, desktop computer, display or printer, so that the processed compliance data may be evaluated.

In some implementations, the system is configured so that the compliance data is more or less continuously provided, processed and updated to a database or an output device, thus permitting more or less continuous or real-time monitoring of the information acquired from the wearable electronic detection devices, and the safety status of the users of the personal protective instruments. Such monitoring may be performed, for example, by a person responsible for safety compliance in a workplace. In further implementations hereof, various data acquired from the wearable electronic detection devices may be compiled by the central controller to create a record, relating to individual users, and/or individual personal protective instruments, for example, a record reflecting user activity in specific week, a month or a year.

In accordance herewith, the information or records compiled by the central controller 155, may be used for a wide range of purposes including, without limitation, at least one of, for safety training purposes, to develop strategies for improvement in safe behavior of users or groups of users, to prevent or limit the incidents, accidents and/or injuries of users in hazardous work environments, and, in the case of the occurrence thereof, to aide in investigating causes of and/or contributing factors to such incidents, accidents and/or injuries.

In some aspects, the present disclosure further comprises the use of a system to prevent or limit the occurrence of incidents, accidents and/or injuries in a workspace, the system comprising:
a plurality of personal protective instruments, each personal protective instrument comprising a PPE beacon configured to transmit a wireless PPE beacon signal;
a plurality of wearable electronic detection devices, each wearable electronic detection device being associated with at least one of the personal protective instruments worn by a given user, each wearable electronic detection device being configured to:
   receive and measure at least one wireless PPE beacon signal transmitted by the at least one associated PPE beacon;
   determine at least one distance-based measure representing the distance between the wearable electronic detection device and the associated at least one personal protective instrument; and
   for the given user, execute at least one safety action according to safety rules data when the determined at least one distance-based measure between the given user's wearable electronic detection device and the at least one of the associated personal protective instruments exceeds minimal distance-based criteria; and a central controller configured to send controlling data including safety rules data to the wearable electronic detection devices to configure the operation of the system according to centralized safety rules.

In some implementations, the system of the present disclosure further comprises one or more control points (CPs). In such implementations, the control point is configured to comprise a beacon (hereafter referred to as a CP beacon), which comprises a power source, a transmitter, a memory, and a processor component allowing for transmission, storage and processing of information. In some example implementations, the control point may be configured to communicate with the central controller, e.g. via a wireless or wired network. An example implementation of an automatic safety system that includes a control point in accordance with the teachings of the present disclosure is further illustrated in FIG. 5.

Referring now to FIG. 5, shown therein are wearable electronic detection devices 150A, 150B comprising a processor component 225, a memory component 230, a receiver component 235, a transmitter component 240, a signaling component 245 and output component 285. The wearable electronic detection device 150 is capable of detecting and identifying a control point 510A, 510B, which provides the wearable electronic detection device with location awareness regarding its proximity to a particular workspace requiring the use of personal protective instruments. In an example implementation, the control point 510A, 510B is a CP beacon, comprising a processor component 515 a memory component 520, a power source 525, and a transmitter component 530. In some example implementations, the control point 510A, 510B also comprises an output device, for example a display, capable of displaying messages to a user and a speaker capable of emitting audio information, such as audio commands, e.g. alerts and voice commands, to a user.

In some implementations, the control point is configured to transmit status data including one or more of control point status data, PPE beacon status data, and wearable electronic detection device status data, to the central controller 155 and receive controlling data from the central controller 155 and execute actions according to safety rules data in the received controlling data.

In some implementations, the control point comprises two CP beacons that are positioned in a serial fashion adjacent to or on either side of an entry point providing access to a workspace and detecting when users with wearable electronic devices enter into the workspace or leave the workspace.

Advantageously, the control point allows multiple users to enter or exit a workspace at the same time, in contrast to conventional systems that require users to pass through one at a time at a physical door, since the control point beacons can be used to determine the number of users entering or exiting a workspace and the wearable electronic detection device for each user can also send a signal to the central controller 155 reporting that it is at the control point.

Referring to FIG. 6, shown therein is an example implementation of a system 600 in accordance with the present disclosure. The system 600 comprises a central controller 155 capable of communicating with a control point comprising two CP beacons 510 and 610, where CP beacon 510 is positioned outside an entry point EW1 relating to a first work area or workspace W1, and CP beacon 610 is positioned inside the entry area EW1. Accordingly, the CP beacons 510 and 610 are physically positioned in a spaced-apart, serial fashion adjacent or near to an entry area of the associated workspace. In accordance herewith, the entry point EW1 may be located immediately adjacent to or in close proximity of W1. Persons wishing to enter workspace W1 are required to wear the safety helmet 110 and the safety gloves 120. In accordance with this example implementation, a user, prior to entering workspace W1, approaches entry point EW1 and the wearable electronic detection device 150 detects the control points 510 and 610 in sequence, thus indicating to the wearable electronic detection device 150 that it is entering the entry point EW1. The system 600 is configured to authenticate the user and thus confirm that the user who is carrying wearable electronic detection device 150 is permitted to enter the workspace W1. The system 600 is further configured, upon authentication of the user, to monitor the distance between the safety helmet 110 and safety glove 120 and the wearable electronic detection device 150 while the user is in workspace W1. For example, the wearable electronic detection device 150 can be configured to detect the CP beacon signal, determine the associated workplace and use safety rules that correspond to the associated workspace. Alternatively, or in addition thereto, the control point can detect when a workplace user with a wearable electronic detection devices enters or leaves the workspace based on the order in which the CP beacons 510 and 610 detect the workplace user's wearable electronic detection device.

In some implementations, the workspace W1 is a permanent workspace. In other implementations, the workspace W1is a temporary workspace, such as a construction site. In yet other implementations, the workspace W1 may be a relatively small space around an individual piece of hazardous equipment, e.g. a space around and including a forklift, a workspace around and including a circle saw etc.

In some example implementations, the control point comprises a signaling component that has a transducer capable of emitting a range of different alert signals, for example, a sound signal, a light signal, a vibrational signal, a heat signal or a combination thereof or any other detectable alert signal. Accordingly, the implementation of the transducer depends on the type of alert signals that can be emitted, and may be one or more of an audio source, a light source, a vibrational source, and a heat source.

In some example implementations, the control point is positioned at a gated entry to a workspace and comprises a software integration (e.g. communication module) to allow communication with the workspace access system to enable the control point to operate in conjunction with a security system that controls access to the workspace. In some example implementations, opening of the gate is electronically controlled, e.g. by a signal transmitted by the central controller 155. In some example implementations, an electronically controlled gate only provides access to a workspace upon a user having authenticated himself or herself, e.g. by use of a control point, and/or by wearing the prescribed personal protective instruments, as signaled by the wearable electronic detection device. In some example implementations, if the central controller 155 detects a safety rule violation, the central controller 155 can send a control signal to maintain the workspace in a certain state until the safety rule violation is resolved. For example, the central controller 155 can configure and send the control signal to not allow the building door to be unlocked until the safety rule violation was resolved.

In some example implementations, the control point comprises a video camera system and software configured to count and identify the number of people at the control point. In some example implementations, via communication with the central controller 155, the control point determines how many wearable electronic detection devices are at the control point or in the workspace that is associated with the control point. If the central controller 155 detected that there are more people than wearable electronic detection devices in the workspace associated with the control point, the central controller 155 can execute the actions configured for that safety rule violation, which can include generating control point or wearable electronic detection device alerts.

In some alternative example implementations, the system may further include a mechanical component that is coupled to the wearable electronic detection device. Thus, in some implementations, initiating work with a hazardous piece of equipment, for example by a mechanical power or start button used to start the piece of equipment, initiates monitoring between a wearable electronic detection device and a PPE beacon. In such an implementation, a user is notified by the automated system of any deficiencies in safety equipment required or recommended to operate the equipment.

The present disclosure further relates to at least one process for monitoring the use of personal protective equipment. Accordingly, the present disclosure provides, in at least one aspect, an automated process for monitoring the use of personal protective equipment, the process comprising:
transmitting a plurality of wireless PPE beacon signals from a plurality of personal protective instruments used by users;
receiving at least one wireless PPE beacon signal at a wearable electronic detection device used by a user, the at least one wireless PPE beacon signal transmitted from at least one personal protective instrument used by the user and associated with the wearable electronic detection device;
determining at least one distance-based measure representing the distance between the user's wearable electronic detection device and the associated at least one personal protective instrument; and
executing at least one safety action according to safety rules data when the determined at least one distance -based measure of the distance between the user's wearable electronic detection device and the user's at least one associated personal protective instrument exceeds the minimal distance-based criteria.

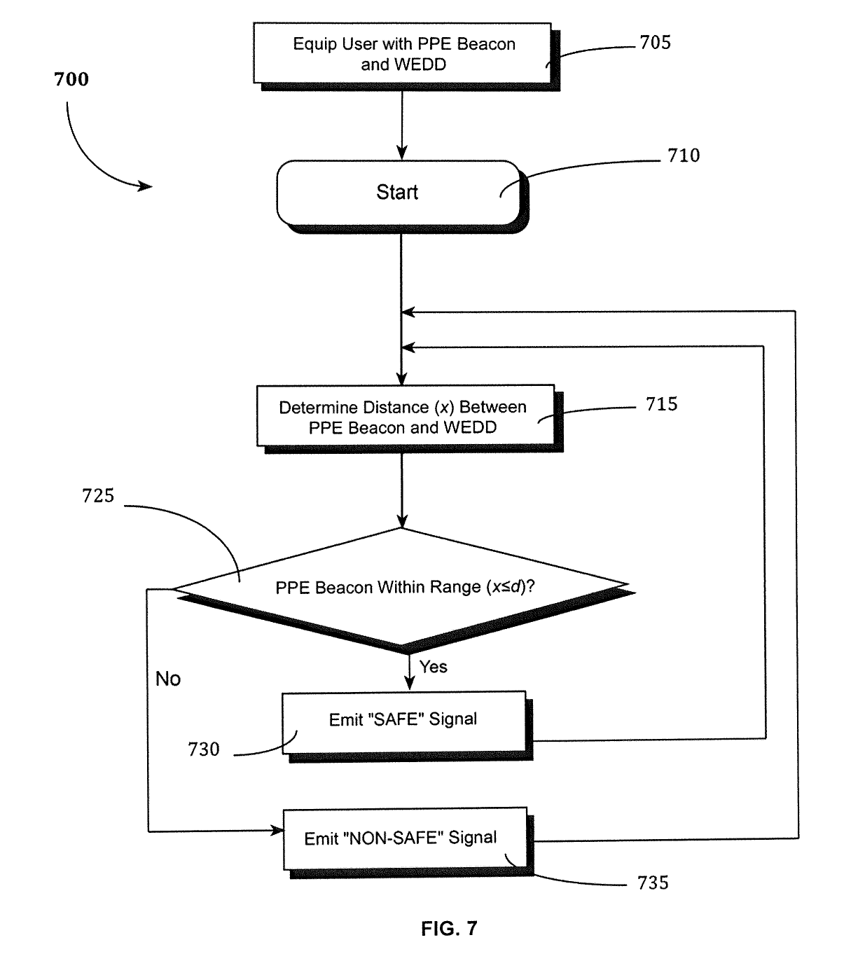

In one example implementation hereof, the present disclosure provides a process shown in FIG. 7. Thus, referring now to FIG. 7, the present disclosure includes, an automated process 700 for monitoring if a safety violation has occurred during the use of personal protective equipment, the process 700 comprising a first step 705 comprising equipping a person with at least one personal protective instrument comprising a PPE beacon, and equipping the person with a wearable electronic detection device. Prior to this step, the process comprises initializing the system and sending controlling data to the wearable electronic devices and PPE beacons to control how they will operate.

The process 700 further comprises a second step 710 of starting an automated process, comprising a third step 715, a fourth step 725, a fifth step 730 and a sixth step 735. The second step 710 may be initiated in a variety of ways, for example by a user of the PPE beacon and wearable electronic detection device turning on the wearable electronic detection device. In another implementation, the second step 710 may be performed by the wearable electronic detection device detecting a control point.

The process 700 further comprises a third step 715 comprising determining the distance x between the PPE beacon and the wearable electronic detection device for a given user.

The process 700 further comprises a fourth step 725 comprising determining whether the distance x between the PPE beacon and the wearable electronic detection device has exceeded the minimal signaling distance d. In the event the minimal signaling distance d has not been exceeded, the automatic system emits a safe signal at a fifth step 730. In the event x exceeds the minimal signaling distance, the automatic system emits a non-safe (i.e. alert) signal at a sixth step 735 depending on the usage of the personal protective instruments and the safety rules governing usage. Steps 730 and 735 are initiated by step 725, as hereinbefore described. Following completion of step 730 or step 735, the process 700 is automatically iterated starting at step 715.

In an alternative implementation, at steps 715 to 735, the automated safety monitoring process 700 can measure the RSS value and emit an alert signal when the RSS decreases below the configured acceptable RSS value.

In an alternative implementation, at steps 715 to 735, the automated safety monitoring process 700 can store a plurality of detected RSS values and emit an alert signal when a significant number of detected RSS values within a defined time period is below a predefined threshold.

In an alternative implementation, at steps 715 to 735, the automated safety monitoring process 700 can detect the time difference between a transmitted signal to the PPE from a wearable electronic detection device and a subsequent reception of a signal at the wearable electronic detection device that was sent by the PPE and then emit an alert signal if the time difference exceeds a predefined acceptable value.

In an alternative implementation, at steps 715 to 735, the automated safety monitoring process 700 can store a plurality of detected duration-of-time values and emit an alert signal when a significant number of stored duration-of-time values within a defined time period is sufficiently long, for example, relative to a baseline duration-of-time value, to indicate separation between the wearable electronic detection device and one of the PPE beacons.

In an alternative implementation, at steps 715 to 735, the automated safety monitoring process 700 can use a plurality of minimal distance thresholds, e.g. d1, d2, d3, d4, and emit a different alert signal, such as a different intensity or different type of signal, when the determined minimum distance exceeds each minimal signaling distance.

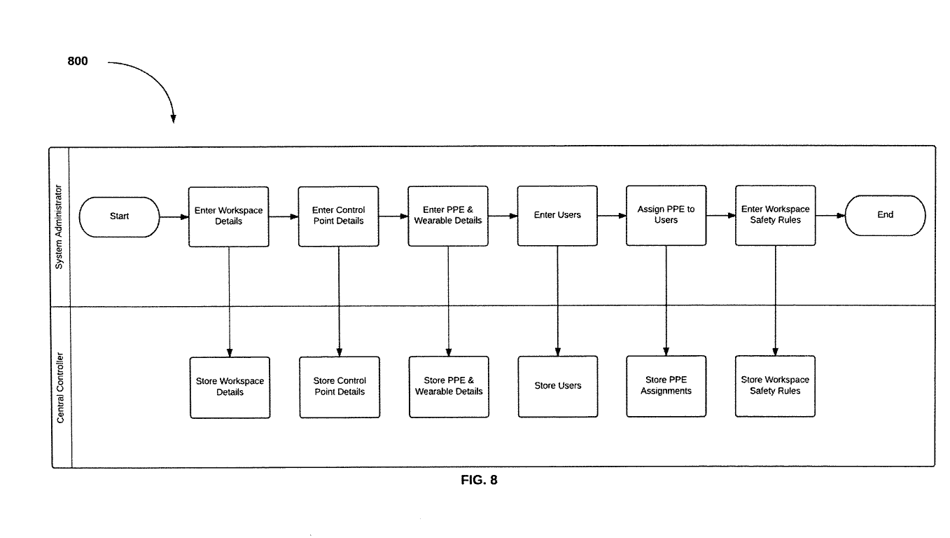

The present disclosure further includes a description of the performance of processes to direct the central controller, as well as processes executed by the central controller. Example implementations of such processes are provided in FIG. 8 to FIG. 12.

In one example implementation hereof, the present disclosure includes the process shown in FIG. 8. Thus, referring now to FIG. 8, the present disclosure includes an initialization process 800 for initializing the automated safety system comprising the entering and storing of controlling data, for example, by a system administrator, into the central controller 155, the controlling data including but not limited to, controlling data including user data (including but not limited to one or more of identification data, safety violation history data, and work duty data, for example), device data e.g. for wearable electronic detection devices, beacons, and control points (including but not limited to one or more of device identifier data, device status data, and device age data, for example), workspace data (including but not limited to, workspace location, safety rules that apply to the workspace, and safety compliance history data), safety rule data (including but not limited to, different types of safety rules that can be specified for different workspaces and different types of personal protective instruments, for example) and executable actions (including safety actions to take in the event of a safety violation).

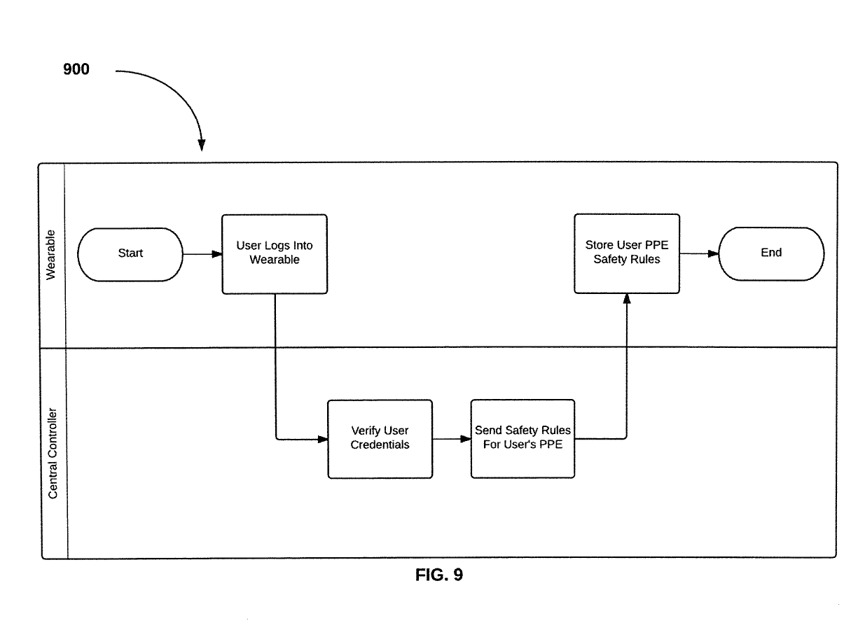

In one example implementation hereof, the present disclosure includes the process shown in FIG. 9. Thus, referring now to FIG. 9, the present disclosure includes an initialization process 900 for the wearable electronic detection device comprising the input of user credentials (e.g. login ID, password) into the wearable electronic detection device and the transmission of the user credentials to the central controller 155 for verification. The process 900 further comprises the central controller 155 transmitting controlling data, including but not limited to, safety rules data including safety rules to the wearable electronic detection device. The safety rules are in regards to the one or more PPEs that the user should be using and the safety violation actions that the wearable electronic detection device should take if a safety violation occurs.

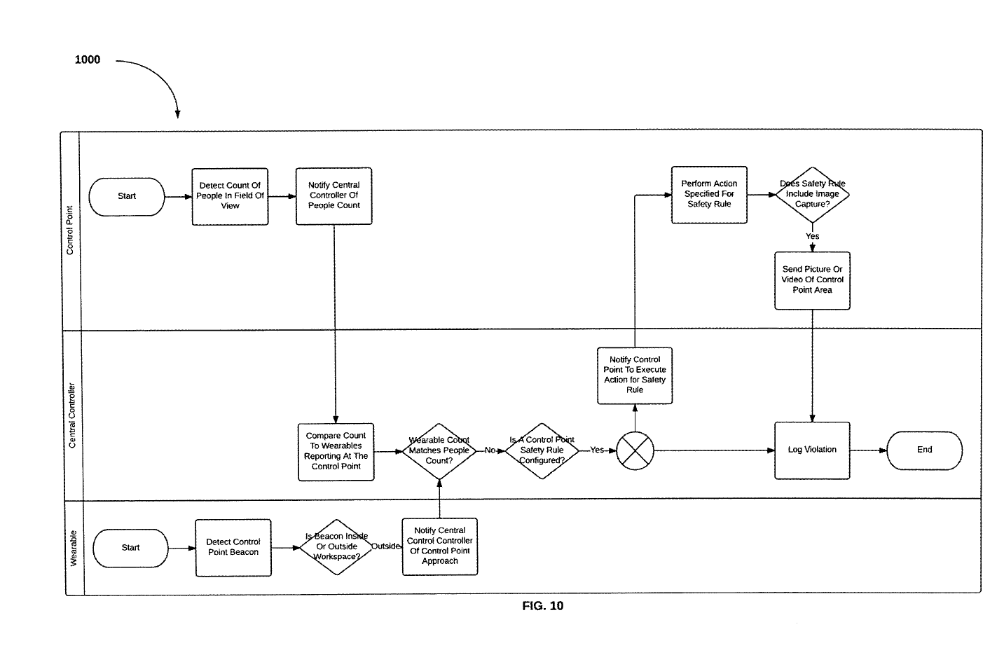

In one example implementation hereof, the present disclosure includes the process shown in FIG. 10. Thus, referring now to FIG. 10, the present disclosure includes an automated process 1000 for monitoring the use of personal protective equipment using a control point. In this example, a user is equipped with a wearable electronic detection device and the user approaches a control point comprising two CP beacons placed outside and inside an entry point to a work area. The process 1000 comprises the wearable electronic detection device detecting the CP beacons in sequence, the outside CP beacon first and the inside CP beacon second, which the wearable electronic detection device interprets and sends a signal to the central controller to notify the central controller that it is approaching a control point at an entry point. At this point, in some implementations, the central controller sends controlling data including safety rule data to the wearable electronic detection device about the safety rules that are to be implemented in the workspace associated with that particular control point. The user's wearable electronic detection device then monitors the PPE's that the user is using to ensure compliance with the safety rules.

The process 1000 further comprises the central controller receiving status data from the control point regarding the number, and in some implementations of the control point, the identity of people at the control point. The central controller compares the count of wearable electronic detection devices to the count of people to determine if the counts match. In the case of example process 1000, the numbers do not match, resulting in the central controller determining if a safety rule exists and then transmitting the controlling data to the control point to execute an action (e.g. emitting an alert), and the central controller executing an action (e.g. logging the violation) based on the safety rule regarding a user not being equipped with a wearable electronic detection device. If the safety rule includes image capture, then the control point can send image data or video data of the workspace area to the central controller.

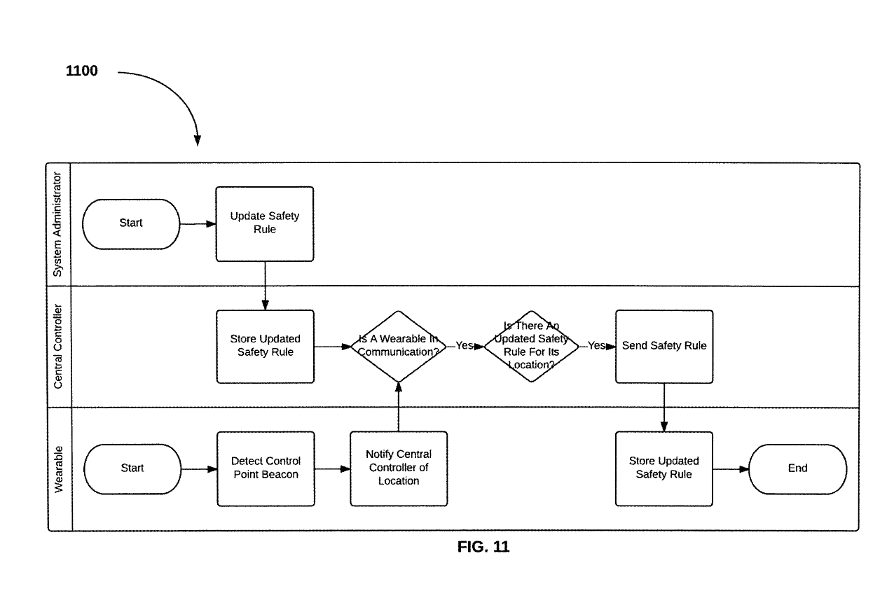

In one example implementation hereof, the present disclosure includes a process shown in FIG. 11. Thus, referring now to FIG. 11, the present disclosure includes an updating process 1100 comprising the entering of controlling data, for example, updated safety rules into the central controller for storage. For instance, a system administrator may enter or send the updated safety rules to the central controller which then stores safety rule data for the updated safety rules. The process 1100 further comprises the wearable electronic detection device detecting a CP beacon (or in other implementations using alternative ways to detect its location as described previously), notifying the central controller that it is at a control point or a certain location and requesting any safety rule updates for the control point or location. The central controller then determines where there is an updated safety rule for the control point/location and if so sends the updated safety rule data to the wearable electronic detection device for storage and usage in monitoring the PPEs associated with the wearable electronic detection device.

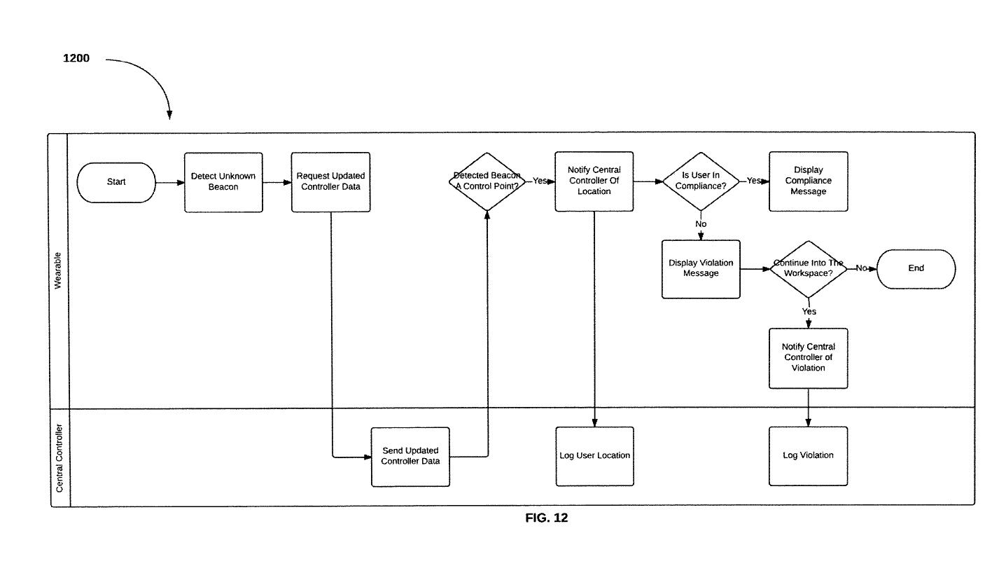

In one example implementation hereof, the present disclosure includes a process shown in FIG. 12. Thus, referring now to FIG. 12, the present disclosure includes an automatic process 1200 for monitoring the use of personal protective equipment that has a beacon that has not been specified in the controlling data. The process 1200 comprises the wearable electronic detection device receiving a beacon wireless signal comprising a unique identifier for which the wearable electronic detection device does not have any corresponding controlling data to identify. The process 1200 further comprises the wearable electronic detection device requesting updated controlling data from the central controller with respect to the unknown beacon and the central controller transmitting updated controlling data to the wearable electronic detection device that indicates to the wearable electronic detection device that the beacon is a CP beacon. The wearable electronic detection device then notifies the central controller of its location at the control point. The wearable electronic detection device then determines whether the user is in compliance with safety rules that have been defined for that control point and executes the action based on the safety rules data for that control point location as illustrated when the safety rule has been violated.

At least some of the elements of the various automated processes described herein are implemented via software and may be written in a high-level procedural language such as object-oriented programming or a scripting language. Accordingly, the program code may be written in C, C++ or any other suitable programming language and may comprise modules or classes, as is known to those skilled in object-oriented programming. Alternatively, at least some of the elements of the various automated processes described herein that are implemented via software may be written in assembly language, machine language or firmware. In either case, the program code can be stored on a storage media or on a computer readable medium that is readable by a general or special purpose electronic device having a processor, an operating system and the associated hardware and software that implements the functionality of at least one of the implementations described herein. The program code, when read by the electronic device, configures the electronic device to operate in a new, specific and defined manner in order to perform at least one of the methods described herein.

Furthermore, at least some of the methods described herein are capable of being distributed in a computer software product comprising a transitory or non-transitory computer readable medium that bears computer usable instructions for one or more processors. The medium may be provided in various forms such as, but not limited to, one or more diskettes, compact discs, tapes, chips, USB keys, external hard drives, wire-line transmissions, satellite transmissions, internet transmissions or downloads, magnetic and electronic storage media, digital and analog signals, tablet (e.g. iPad) or smartphone (e.g. iPhones) apps, and the like. The computer useable instructions may also be in various forms, including compiled and non-compiled code.

Accordingly, in one aspect, the present disclosure includes a computer readable medium comprising a plurality of instructions that, when executed on a processing unit of a device, cause the device to implement a process for monitoring the use of personal protective equipment according to any of the implementations of the processes described herein.

While the applicant's teachings described herein are in conjunction with various implementations for illustrative purposes, it is not intended that the applicant's teachings be limited to such implementations. On the contrary, the applicant's teachings described and illustrated herein encompass various alternatives, modifications, and equivalents, without departing from the implementations described herein, the general scope of which is defined in the appended claims.

We claim:

1. A system for automatic monitoring of the use of personal protective equipment (PPE), the system comprising:
a plurality of personal protective instruments, each personal protective instrument comprising a PPE beacon configured to transmit a wireless PPE beacon signal;
a plurality of wearable electronic detection devices, each wearable electronic detection device being associated with at least one of the personal protective instruments worn by a given user, each wearable electronic detection device being configured to:
receive and measure at least one wireless PPE beacon signal transmitted by the at least one associated PPE beacon;
determine at least one distance-based measure representing the distance between the wearable electronic detection device and the associated at least one personal protective instrument; and
for the given user, execute at least one safety action according to safety rules data when the determined at least one distance-based measure between the given user's wearable electronic detection device and the at least one of the associated personal protective instruments exceeds minimal distance-based criteria; and
a central controller configured to send controlling data including safety rules data to the wearable electronic detection devices to configure the operation of the system according to centralized safety rules.

2. The system according to claim 1, wherein the wearable electronic detection device is configured to detect at least one received signal strength (RSS) level of the at least one PPE beacon signal, compare the at least one detected RSS level to an acceptable RSS level and execute a safety action when the at least one received RSS level is less than the acceptable RSS level.

3. The system according to claim 1, wherein the wearable electronic detection device is configured to detect a plurality of received signal strength (RSS) levels of the at least one PPE beacon signal, and to perform the at least one safety action when a proportion of the detected RSS levels is less than a proportion threshold.

4. The system according to claim 1, wherein the wearable electronic detection device is configured to determine a time difference between transmitting a query signal to the at least one PPE beacon and receiving a response signal from the at least one PPE beacon and to perform the at least one safety action when the time difference is larger than a time difference threshold.

5. The system according to claim 1, wherein the wearable electronic detection device is configured to repeatedly determine a time difference between transmitting a query signal to the at least one PPE beacon and receiving a response signal from the at least one PPE beacon and to perform the at least one safety action when a percentage of the repeatedly determined time differences is larger than a time separation threshold.

6. The system according to any one of claims 1 to 5, wherein there are a plurality of thresholds with each threshold being associated with a successively larger distance and the at least one safety action has a larger intensity when a threshold associated with a larger distance is exceeded.

7. The system according to any one of claims 1 to 6, wherein at least one of the PPE beacons comprises an integration point to a sensor on the at least one associated personal protective instrument for determining a health status of the at least one personal protective instrument and sending corresponding health status data to the associated wearable electronic detection device.

8. The system according to any one of claims 1 to 7, wherein the wearable electronic detection device is configured to send compliance data to the central controller.

9. The system according to claim 8, wherein the compliance data comprises at least one of data on whether a safety rule was violated, what safety rule was violated, how the safety rule was violated, how long the safety rule violation occurred, how the safety violation was resolved and the location of the safety violation.

10. The system according to any one of claims 1 to 9, wherein the wearable electronic detection device is configured with a GPS integrated circuit or a WiFi integrated circuit to determine it is located at or within a given workspace.

11. The system according to any one of claims 1 to 9, wherein the system further comprises a control point (CP) associated with a workspace, the control point comprising a CP beacon that emits a CP beacon signal indicating the associated workspace and the wearable electronic detection device being configured to detect the CP beacon signal, determine the associated workplace and use safety rules that correspond to the associated workspace.

12. The system according to any one of claims 1 to 9, wherein the system further comprises a control point (CP) associated with a workspace, the control having two CP beacons that are physically positioned in a spaced-apart, serial fashion adjacent or near to an entry area of the associated workspace for detecting when a workplace user with a wearable electronic detection devices enters or leaves the workspace based on the order in which the CP beacons detect the workplace user's wearable electronic detection device.

13. The system according to claim 10 or claim 11, wherein the control point comprises a video camera system to generate image data that is used to count the number of users at the control point and compare the number of counted users with a number of detected wearable electronic detection devices at the control point and to execute at least one safety action according to safety rules data including emitting an alert signal if the number of users does not equal the number of detected wearable electronic detection devices.

14. The system according to claim 10 or claim 11, wherein the control point comprises an integration point for a building access system for a workspace and when the central controller detects a violation of a safety rule, the central controller sends a control signal to maintain the workspace in a certain state until the safety rule violation is resolved.

15. The system according to any one of claims 1 to 14, wherein the PPE beacons use one of an RFID communication protocol, a WiFi communication protocol, a BlueTooth communication protocol , a radio frequency (RF) communication protocol or a Zigbee communication protocol.

16. The system according to any one of claims 1 to 15, wherein the wearable electronic detection device is configured to emit an alert signal to the user of the wearable electronic detection device during or after a safety rule violation.

17. The system according to any one of claims 1 to 16, wherein the system further comprises an output device coupled to the central controller to receive operational data therefrom regarding usage of the personal protective equipment and the output device is configured to output the operational data.

18. A use of a system according to any one of claims 1 to 17, to prevent or limit the incidence of accidents, incidents and/or injuries of users in a workplace.

19. An automated process for monitoring the use of personal protective equipment (PPE), the process comprising:
transmitting a plurality of wireless PPE beacon signals from a plurality of personal protective instruments used by users;
receiving at least one wireless PPE beacon signal at a wearable electronic detection device used by a user, the at least one wireless PPE beacon signal transmitted from at least one personal protective instrument used by the user and associated with the wearable electronic detection device;
determining at least one distance-based measure representing the distance between the user's wearable electronic detection device and the associated at least one personal protective instrument; and
executing at least one safety action according to safety rules data when the determined at least one distance -based measure of the distance between the user's wearable electronic detection device and the user's at least one associated personal protective instrument exceeds the minimal distance-based criteria.

20. The process according to claim 19, wherein the user's wearable electronic detection device determines the at least one distance-based measure and performs the at least one safety action.

21. The process according to claim 19 or claim 20, wherein the process comprises using a central controller for sending controlling data including safety rules data to the wearable electronic detection devices for configuration thereof according to centralized safety rules.

22. The process according to any one of claims 19 to 21, wherein the process comprises detecting at least one received signal strength (RSS) level of the at least one PPE beacon signal, comparing the at least one detected RSS level to an acceptable RSS level and executing the at least one safety action when the at least one received RSS level is less than the acceptable RSS level.

23. The process according to any one of claims 19 to 21, wherein the process comprises detecting a plurality of received signal strength (RSS) levels of the at least one PPE beacon signal, performing the at least one safety action when a proportion of the detected RSS levels is less than a proportion threshold.

24. The process according to any one of claims 19 to 21, wherein the process comprises determining a time difference between transmitting a query signal to the at least one PPE beacon and receiving a response signal from the at least one PPE beacon and performing the at least one safety action when the time difference is larger than a time difference threshold.

25. The process according to any one of claims 19 to 21, wherein the process comprises repeatedly determining a time difference between transmitting a query signal to the at least one PPE beacon and receiving a response signal from the at least one PPE beacon and performing the at least one safety action when a percentage of the repeatedly determined time differences is larger than a time separation threshold.

26. The process according to any one of claims 19 to 25, wherein the process comprises using a plurality of thresholds with each threshold being associated with a successively larger distance and the at least one safety action having a larger intensity when a threshold associated with a larger distance is exceeded.

27. The process according to any one of claims 19 to 26, wherein the process comprises receiving a voltage signal from a sensor on the at least one associated personal protective instrument for determining a health status of the at least one personal protective instrument and sending corresponding health status data to the associated wearable electronic detection device.

28. The process according to any one of claims 21 to 27, wherein the process comprises sending compliance data from the wearable electronic detection device to the central controller.

29. The process according to claim 28, wherein the compliance data comprises at least one of data on whether a safety rule was violated, what safety rule was violated, how the safety rule was violated, how long the safety rule violation occurred, how the safety violation was resolved and the location of the safety violation.

30. The process according to any one of claims 19 to 29, wherein the process comprises using a GPS integrated circuit or a WiFi integrated circuit with the wearable electronic detection device to determine its location.

31. The process according to any one of claims 19 to 29, wherein the process further comprises using a control point (CP) associated with a workspace, the control point comprising a CP beacon that emits a CP beacon signal indicating the associated workspace and the process comprises using the wearable electronic detection device being to detect the CP beacon signal, to determine the associated workplace and to use safety rules that correspond to the associated workspace.

32. The process according to any one of claims 19 to 29, wherein the process comprises using a control point (CP) associated with a workspace, the control having two CP beacons that are physically positioned in a spaced-apart, serial fashion adjacent or near to an entry area of the associated workspace and the process comprises detecting when a workplace user with a wearable electronic detection devices enters or leaves the workspace based on the order in which the CP beacons detect the workplace user's wearable electronic detection device.

33. The process according to claim 31 or claim 32, wherein the control point comprises a video camera system for generating image data and the process comprises using the image data to count the number of users at the control point, comparing the counted users with a number of detected wearable electronic detection devices at the control point and executing at least one safety action according to safety rules data including emitting an alert signal if the number of users does not equal the number of detected wearable electronic detection devices.

34. The process according to claim 31 or claim 32, wherein the control point comprises an integration point for a building access system for a workspace and when the central controller detects a violation of a safety rule, the process comprises using the central controller to send a control signal to maintain the workspace in a certain state until the safety rule violation is resolved.

35. The process according to any one of claims 19 to 34, wherein the process comprises using the wearable electronic detection device to emit an alert signal to the user of the wearable electronic detection device during or after a safety rule violation.

36. The process according to any one of claims 19 to 35, wherein the process further comprises outputting operational data received from the central controller regarding usage of the personal protective equipment.
